(19) United States
(12) Patent Application Publication
(10) Pub. No.: US 2023/0337655 A1
(43) Pub. Date: Oct. 26, 2023

(54) Bird Nest Prevention Device

(71) Applicant: Harold Fox, Akron, OH (US)

(72) Inventor: Harold Fox, Akron, OH (US)

(21) Appl. No.: 18/299,744

(22) Filed: Apr. 13, 2023

Related U.S. Application Data
(60) Provisional application No. 63/333,174, filed on Apr. 21, 2022.

(51) Int. Cl. A01M 29/32; A01M 29/12; A01M 29/06

(52) U.S. Cl. CPC A01M 29/32; A01M 29/12; A01M 29/06

(57) ABSTRACT

A bird nest prevention device is provided. The device is comprised of a deformable body that can be placed in openings of an outdoor structure where birds desire to nest. As a result, the device prevents said birds from nesting and also prevents the owner of the structure from constantly monitoring and destroying bird nests.

### CROSS-REFERENCE TO RELATED APPLICATION

The present application claims priority to, and the benefit of, U.S. Provisional Application No. 63/333,174, which was filed on Apr. 21, 2022, and is incorporated herein by reference in its entirety.

### FIELD OF THE INVENTION

The present invention relates generally to the field of bird deterrents. More specifically, the present invention relates to a bird nest prevention device. The device is comprised of a deformable body that can be placed in a space in the frame of a carport, barn, garage, etc. such that a bird cannot build a nest in said opening. Accordingly, the present disclosure makes specific reference thereto. Nonetheless, it is to be appreciated that aspects of the present invention are also equally applicable to other like applications, devices, and methods of manufacture.

### BACKGROUND

Birds commonly build nests to house and raise their young in openings within homes, garages, carports, and any other convenient outdoor structure. However, homeowners may not want birds to nest in their outdoor structures. As a result, said homeowners may try to prevent a bird from forming a nest by constantly clearing away and collecting nesting materials within their structure. However, this may not be an effective enough deterrent and birds may continue to attempt to build nests in the same spots.

Therefore, there exists a long-felt need in the art for a bird deterrent device. There also exists a long-felt need in the art for a bird nest prevention device. More specifically, there exists a long-felt need in the art for a bird nest prevention device that prevents birds from nesting within structures such as, but not limited to, carports, barns, garages, and other outdoor structures of the like.

The subject matter disclosed and claimed herein, in one embodiment thereof, comprises a bird nest prevention device. The device is comprised of a deformable body that can be placed within spaces of an outdoor structure such as, but not limited to, a carport, a garage, a barn, etc., to prevent birds from nesting in said spaces. In one embodiment, the device is comprised of at least one fastener that further secures the device within the space. The device may also be comprised of other deterrent features such as bird-repelling scents and indicia that mimics birds of prey.

In this manner, the bird nest prevention device of the present invention accomplishes all the foregoing objectives and provides a bird deterrent device. During use, the device prevents birds from nesting within structures such as, but not limited to, carports, barns, garages, and other outdoor structures of the like. As a result, the owner of said structure does not have to consistently monitor and dispose of bird nests in their structure.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bird nest prevention device comprised of a deformable body that in one embodiment can be placed in between a carport frame and frame support to prevent birds from nesting in between the frame and support. The body is preferably made from a deformable foam material such as, but not limited to, foam. This material allows the body to be easily positioned within various spaces within a barn, garage, carport (i.e., between the frame and frame support), etc., The foam of the body is preferably easily cut to allow a user to customize the shape of the body to fit into any area of a barn, garage, carport, etc.

In one embodiment, the perimeter edge of the body is comprised of at least one fastener. The fastener is preferably an adhesive fastener or a magnet fastener. The fasteners can be used to adhesively secure the body into a space where a bird may form a nest, such as, but not limited to, between the frame and frame support of a carport.

In one embodiment, the side walls of the body are comprised of at least one indicia. In one embodiment, the indicia may resemble the head and/or full body of a bird of prey such as, but not limited to, an owl, a hawk, an eagle, etc., to visually deter birds from approaching the device is impregnated with at least one scent that repels birds.

The present invention is also comprised of a method of using the device. First, a device is provided comprised of a body made of a foam material. Then, the body can be inserted into an opening in a structure such as, but not limited to, a carport, a garage, a barn, etc. More specifically, the body is inserted between a carport frame and a frame support. In an embodiment of the device wherein the body is comprised of a fastener, the fastener can be adhered to the area the device is being inserted into/between.

Accordingly, the bird nest prevention device of the present invention is particularly advantageous as it provides a bird deterrent device. More specifically, the device prevents birds from nesting within structures such as, but not limited to, carports, barns, garages, and other outdoor structures of the like. As a result, the owner of said structure does not have to consistently monitor and dispose of bird nests in their structure. In this manner, the bird nest prevention device overcomes the limitations of existing bird nesting deterrent methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a bird nest prevention device of the present invention in accordance with the disclosed architecture; and

FIG. 2 illustrates a flowchart of a method of using one potential embodiment of a bird nest prevention device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a bird deterrent device. There also exists a long-felt need in the art for a bird nest prevention device. More specifically, there exists a long-felt need in the art for a bird nest prevention device that prevents birds from nesting within structures such as, but not limited to, carports, barns, garages, and other outdoor structures of the like.

The present invention, in one exemplary embodiment, is comprised of a bird nest prevention device comprised of a deformable body. The device can be placed in between a carport frame and frame support to prevent birds from nesting in between the frame and support. The body is preferably made from a deformable foam material such as, but not limited to, foam, which allows the body to be easily positioned within various spaces within a barn, garage, carport (i.e., between the frame and frame support), etc. The foam of the body is preferably easily cut to allow a user to customize the shape of the body to fit into any area of a barn, garage, carport, etc.

In one embodiment, the perimeter edge of the body is comprised of at least one fastener. The fastener is preferably an adhesive fastener or a magnet fastener. The fasteners can be used to adhesively secure the body into a space where a bird may form a nest, such as, but not limited to, between the frame and frame support of a carport.

In one embodiment, the side walls of the body are comprised of at least one indicia. In one embodiment, the indicia may resemble the head and/or full body of a bird of prey such as, but not limited to, an owl, a hawk, an eagle, etc., to visually deter birds from approaching the device is impregnated with at least one scent that repels birds.

The present invention is also comprised of a method of using the device. First, a device is provided comprised of a body made of a foam material. Then, the body can be inserted into an opening in a structure such as, but not limited to, a carport, a garage, a barn, etc. More specifically, the body is inserted between a carport frame and a frame support. In an embodiment of the device wherein the body is comprised of a fastener, the fastener can be adhered to the area the device is being inserted into/between.

Accordingly, the bird nest prevention device of the present invention is particularly advantageous as it provides a bird deterrent device. More specifically, the device prevents birds from nesting within structures such as, but not limited to, carports, barns, garages, and other outdoor structures of the like. As a result, the owner of said structure does not have to consistently monitor and dispose of bird nests in their structure. In this manner, the bird nest prevention device overcomes the limitations of existing bird nesting deterrent methods known in the art.

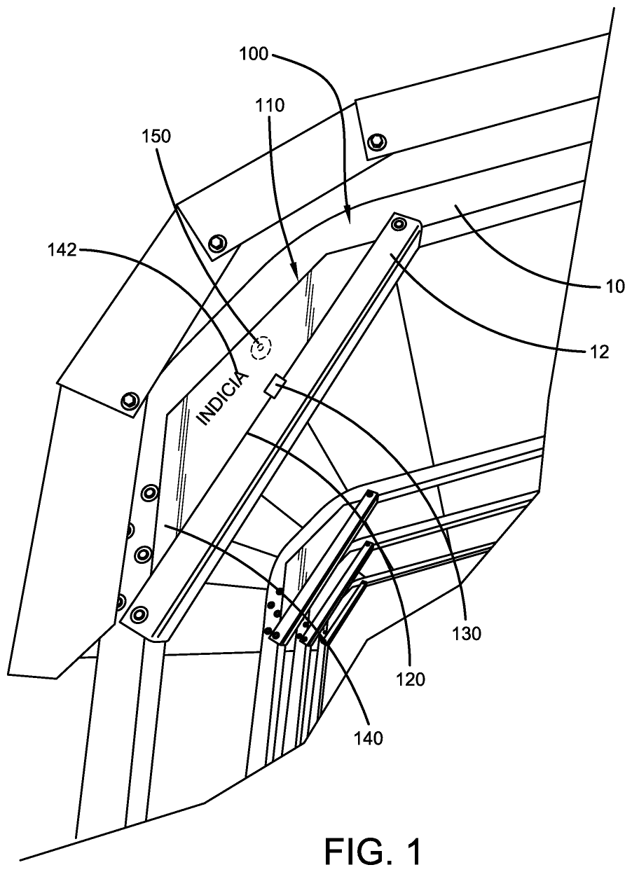

Referring initially to the drawings, FIG. 1 illustrates a perspective view of one potential embodiment of a bird nest prevention device of the present invention in accordance with the disclosed architecture. The device 100 is comprised of a deformable body 110 that in one embodiment can be placed in between a carport frame 10 and frame support 12 to prevent birds from nesting in between the frame 10 and support 12. The body 110 is preferably made from a deformable foam material. The deformable nature of the foam allows the body 110 to be easily positioned within various spaces within a barn, garage, carport (i.e., between the frame 10 and frame support 12), etc. The foam is preferably a waterproof foam to prevent rain from degrading the foam material. The foam of the body 110 is preferably easily cut to allow a user to customize the shape of the body 110 to fit into any area of a barn, garage, carport, etc.

In one embodiment, the perimeter edge 120 of the body 110 is comprised of at least one fastener 130 of any type known in the art. The fastener 130 is preferably comprised of an adhesive fastener with a peelable cover. The fastener 130 can be used to adhesively secure the body 110 into a space where a bird may form a nest, such as, but not limited to, between the frame 10 and frame support 12 of a carport. In another embodiment, the fastener 120 is comprised of a magnet to attach the body 110 to a metal frame 10 and frame support 12 of a carport.

In one embodiment, the side walls 140 of the body 110 are comprised of at least one indicia 142. The indicia 142 may be any pattern, color, logo, word, simulated texture, picture, etc. In one embodiment, the indicia 142 may resemble the head and/or full body of a bird of prey such as, but not limited to, an owl, a hawk, an eagle, etc. In this manner, the indicia 142 visually deters birds from approaching the device 100 and/or approaching the structure the device 100 is positioned within.

In another embodiment, the body 110 is impregnated with at least one scent 150. Said scent is preferably a scent that repels birds. The scent may include, but is not limited to, peppermint, cayenne pepper, apple cider vinegar, lavender, citronella, lemongrass, etc. In this manner, the scent 150 further repels birds from approaching the device 100 and/or approaching the structure the device 100 is positioned within.

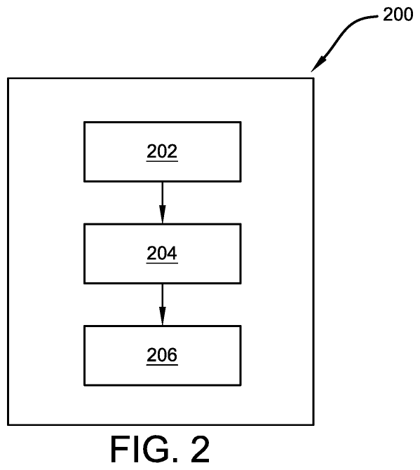

The present invention is also comprised of a method of using 200 the device 100, as seen in FIG. 2. First, a device 100 is provided comprised of a body 110 made of a foam material [Step 202]. Then, the body 110 can be inserted into an opening in a structure such as, but not limited to, a carport, a garage, a barn, etc., [Step 204]. More specifically, the body 110 is inserted between a carport frame 10 and a frame support 12. In an embodiment of the device 100 wherein the body 110 is comprised of a fastener 130, the fastener 130 can adhere to the area the device 100 is being inserted into/between [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “bird nest prevention device” and “device” are interchangeable and refer to the bird nest prevention device 100 of the present invention.

Notwithstanding the foregoing, the bird nest prevention device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the bird nest prevention device 100 as shown in the FIGS. are for illustrative purposes only, and that many other sizes and shapes of the bird nest prevention device 100 are well within the scope of the present disclosure. Although the dimensions of the bird nest prevention device 100 are important design parameters for user convenience, the bird nest prevention device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A bird nest prevention device comprising:
a body comprised of a deformable material; and
an outside edge of the body comprised of a fastener.

2. The bird nest prevention device of claim 1, wherein the deformable material is comprised of a foam material.

3. The bird nest prevention device of claim 2, wherein the foam material is comprised of a waterproof foam.

4. The bird nest prevention device of claim 1, wherein the fastener is comprised of an adhesive fastener.

5. The bird nest prevention device of claim 1, wherein the fastener is comprised of a magnet.

6. A bird nest prevention device comprising:
a body comprised of a deformable material;
an outside edge of the body comprised of a fastener;
an indicia; and
a scent.

7. The bird nest prevention device of claim 6, wherein the scent is impregnated within the body.

8. The bird nest prevention device of claim 6, wherein the scent is comprised of a peppermint, a cayenne pepper, an apple cider vinegar, a lavender, a citronella, or a lemongrass scent.

9. The bird nest prevention device of claim 6, wherein the indicia is comprised of a head of a bird of prey.

10. The bird nest prevention device of claim 9, wherein the bird of prey is comprised of an owl, a hawk, or an eagle.

11. The bird nest prevention device of claim 6, wherein the deformable material is comprised of a foam material.

12. The bird nest prevention device of claim 11, wherein the foam material is comprised of a waterproof foam.

13. The bird nest prevention device of claim 6, wherein the fastener is comprised of an adhesive fastener.

14. The bird nest prevention device of claim 6, wherein the fastener is further comprised of a magnet.

15. A method of using a bird nest prevention device, the method comprising the following steps:
providing a bird nest prevention device comprised of body comprised of a foam material; and
inserting the body into an opening.

16. The method of claim 15, wherein the opening is an opening in a structure.

17. The method of claim 16, wherein the structure is comprised of a carport, a barn, or a garage.

18. The method of claim 15, wherein the body is further comprised of a fastener.

19. The method of claim 18 further comprised of a step of securing the body within the opening using the fastener.

20. The method of claim 18, wherein the fastener is comprised of an adhesive or a magnet.
